(19) United States
(12) Patent Application Publication
(10) Pub. No.: US 2022/0244407 A1
(43) Pub. Date: Aug. 4, 2022

(54) Method for Generating a Three-Dimensional Environment Model Using GNSS Measurements

(71) Applicant: Robert Bosch GmbH, Stuttgart (DE)

(72) Inventors: Christian Skupin, Garbsen (DE); Nikolay Mikhaylov, Hildesheim (DE); Wen Ren, Hildesheim (DE); Andreas Hinrichs, Rieste (DE)

(21) Appl. No.: 17/621,869

(22) PCT Filed: Jul. 8, 2020
(86) PCT No.: PCT/EP2020/069256

§ 371 Date: Dec. 22, 2021

(30) Foreign Application Priority Data
Jul. 18, 2019 (DE) 10 2019 210 659.5

(51) Int. Cl. G01S 19/42; G01S 19/14; G01S 19/33; G01S 19/25

(52) U.S. Cl. CPC G01S 19/428; G01S 19/252; G01S 19/33; G01S 19/14

(57) ABSTRACT

The disclosure relates to a method for generating a three-dimensional environment model using GNSS measurements, comprising at least the following steps: a) receiving a plurality of measuring data sets, each of which describes a propagation path of a GNSS signal between a GNSS satellite and a GNSS receiver; b) selecting from the plurality of measuring data sets individual measuring data sets which meet a first selection criterion, the first selection criterion being characteristic for the presence of an object boundary along the propagation path of the GNSS signal; and c) capturing an object boundary of an object in the environment of at least one GNSS receiver using the measuring data sets selected.

The invention concerns a method for generating a three-dimensional environment model using GNSS measurements, a computer program for carrying out the method and a machine-readable storage medium on which the computer program is stored. The invention can be used in particular for autonomous driving.

### PRIOR ART

For autonomous driving, it is important to have the most precise information possible about the ego position of the vehicle. In this regard, 3D environment models are used for many purposes, for instance as 3D ray tracing for example for calculating signal propagation for vehicle-to-vehicle communication or GNSS-based positioning.

Three-dimensional environment models are typically provided in so-called OSM maps (Open Street Map maps) today, which exhibit greatly varying accuracy and for which quality control can be implemented only with difficulty at present owing to the fact that they are open to editing by users. In particular, the building models in environment models today are usually simplified by having a set building height. More accurate 3D models, for example created from aerial photographs or using laser measuring instruments, are not openly available and have to be created or purchased in complicated and expensive fashion.

### DISCLOSURE OF THE INVENTION

The proposal here, as claimed in claim 1, is a method for generating a three-dimensional environment model using GNSS measurements, comprising at least the following steps:
a) receiving a multiplicity of measurement datasets that each describe a propagation path of a GNSS signal between a GNSS satellite and a GNSS receiver,
b) selecting single instances of the measurement datasets that meet a first selection criterion from the multiplicity of measurement datasets, wherein the first selection criterion is characteristic of the presence of an object boundary along the propagation path of the GNSS signal,
c) registering an object boundary of an object in the environment of at least one GNSS receiver by using the selected measurement datasets.

In other words, this concerns a method for environment modelling using GNSS measurements. In this regard, GNSS stands for global navigation satellite system, such as for example GPS (Global Positioning System) or Galileo. The indicated order of steps a), b) and c) can arise as such for a normal operating cycle of the method, or can proceed at least once in the indicated order. In addition, at least steps a), b) and c) can also at least sometimes be carried out in parallel or at the same time.

This allows an entirely new approach to be provided, by means of which a 3D environment model, or building model, can be produced on the basis of GNSS measurements, in particular in light of the ego position (or the GNSS receiver's own position). This advantageously permits 3D environment models to be provided that are reliable and not very expensive to purchase, in particular even if there were a desire to create them for a larger region. In a particularly advantageous manner, it is possible to generate spacious building models, including height details (as a result of further data processing as an added value), from the measurement datasets.

Step a) involves receiving a multiplicity of measurement datasets that each describe a propagation path, or the reception situation, of a GNSS signal between a GNSS satellite and a GNSS receiver. For this purpose (if applicable beforehand), it is possible to record measurement data from which the measurement datasets are formed. In this regard, it is preferred if the measurement data are recorded by one or more (motor) vehicles, for example by way of GNSS receivers and/or environment sensor systems of the vehicles. The vehicles are preferably automobiles that are particularly preferably designed for automated or autonomous operations.

The measurement datasets generally each comprise the following (signal-specific) measurement data:
the (actual) position of the GNSS receiver (at which position the GNSS signal was received),
the satellite position of the GNSS satellite (that transmitted the GNSS signal),
the measured pseudorange (PR) of the GNSS signal, and
the measured signal strength of the GNSS signal.

The (actual) position of the GNSS receiver (for example a reception antenna) can be ascertained (even in the event of disturbances in the signal propagation of the GNSS signal) by means of dual-frequency receivers, for example. Dual-frequency receivers are GNSS receivers that can analyze the radio signals arriving from the GNSS satellites on both coded frequencies (L1 and L2). The measurement principle is—beyond normal pseudoranging (where only L1 is received)—phase measurement of the carrier waves. Applicable dual-frequency receivers may be installed in or on (motor) vehicles, for example. In this regard, the vehicles can be vehicles that are supposed to travel along routes intended specifically for the purpose of creating the measurement datasets, for example.

Alternatively or additionally, an environment sensor system can help to ascertain the (actual) position of the GNSS receiver. This can involve measurement data from the environment sensor system being combined with GNSS measurement data or used on their own. The environment sensor system may be installed in or on (motor) vehicles, for example. In this regard, the position of the GNSS receiver may coincide, by way of illustration, with a vehicle position. The environment sensor system can be an optical sensor (for example a camera), an ultrasonic sensor, a RADAR sensor, a LIDAR sensor or the like, for example.

Given the position of the GNSS receiver and the satellite position, the LOS (line of sight) distance, or the direct (shortest) connecting line, between GNSS satellite and GNSS receiver is generally also known. The pseudorange (PR) is generally measured by way of a propagation delay measurement (for example of the L1 frequency) for the GNSS signal. Given the points position of the GNSS receiver, satellite position and pseudorange, the pseudorange error (PR error) is also known (for example by way of the equation: PR error=measured PR−LOS distance).

The measurement data are advantageously first collected over a relatively long period, for example over at least ten days, and/or using crowdsourcing. In this regard, crowdsourcing can also be described by stating that the measurements of different measurement instances are collated. This can be accomplished for example by collating the measurement data of different vehicles that have stopped in an observation region (from which the 3D environment model is supposed to be created) over an observation period (for example ten days or more).

Step b) involves selecting single instances of the measurement datasets that meet a first selection criterion from the multiplicity of measurement datasets, wherein the first selection criterion is characteristic of the presence of an object boundary along the propagation path of the GNSS signal. The object boundary is situated along the propagation path of the GNSS signal. In other words, this can in particular also be described by stating that the object boundary is situated in or directly beside the propagation path of the GNSS signal. In particular, a borderline case can be considered in this regard, which will be described in more detail below.

Step c) involves registering an object boundary of an object in the environment of at least one GNSS receiver by using the selected measurement datasets. The registering can in particular be detecting or ascertaining the object boundary. The object boundary is in particular an object edge, preferably an object boundary or object edge, that caps an object such as for example a building. In summary and in other words, this can in particular also be described as detection of edge hypotheses of reflecting and/or shadowing objects such as for example buildings.

According to one advantageous configuration, it is proposed that the first selection criterion is that the measurement dataset to be selected within a sorted succession of measurement datasets is the first or last measurement dataset for which disturbed signal propagation (in particular multipath propagation) can be determined. In this regard, it can be assumed that the object boundary is situated at the transition between undisturbed and disturbed signal propagation. The object boundary is generally at a point along the propagation path of the GNSS signal in this scenario.

In many situations, the propagation path corresponds to a connecting line between satellite and reception antenna. This applies at least provided that the GNSS signal undergoes no change of direction on the path from the satellite to the reception antenna. In particular in a borderline case (described more thoroughly in the next but one paragraph), a point that defines the object boundary can be situated on this connecting line.

Alternatively, there can also be provision for the first selection criterion to be that the measurement dataset to be selected within a sorted succession of measurement datasets is the first or last measurement dataset for which no disturbed signal propagation (in particular no multipath propagation) can be determined. In this regard, it can be assumed that the object boundary is situated at the transition between undisturbed and disturbed signal propagation. The object boundary is generally at a point along the propagation path of the GNSS signal in this scenario. In this case too, the object boundary can run through a point on the connecting line between satellite and reception antenna, in particular in certain situations.

In particular, the described detection of the object boundary by way of the first selection criterion can also be understood to mean that this entails a borderline case being considered. In particular, the borderline case considered is where the signal propagation is only just or no longer disturbed (by reflection from a building wall). Moreover, it is possible to establish the hypothesis (also described as an edge hypothesis here) that the object boundary runs through a point that lies on a connecting line between the reception antenna (the GNSS receiver) and the satellite that concerns the borderline case. A satellite that concerns the borderline case can in particular be understood to mean the satellite from which the first or last undisturbed signal (within the sorted succession) was received.

This advantageously permits a transition from disturbed to undisturbed signal propagation to be detected, which, in particular in urban canyons and/or in urban regions, is often representative of the upper edge of a building. Signals that reach the receiver from above the building edge are generally undisturbed (i.e. there is a line of sight between satellite and reception antenna, also called a line-of-sight or LOS situation), whereas signals that reach the receiver from below the building edges vis-à-vis the elevation angle between satellite and reception antenna have generally been reflected at least from a building facade and are therefore disturbed.

Disturbed signal propagation is understood here to mean signal propagation that has been reflected at least once (for example from an object) and for which there is no LOS situation. Other disturbing influences on signal propagation, such as for example errors by the satellite (in particular clock errors or changes of orbit), atmospheric disturbances (in particular deflections in the ionosphere) or errors by the receiver (in particular clock errors or noise), are essentially ignored here. These other disturbing influences can be reduced by applying GNSS correction data (e.g. SSR corrections), however.

According to another advantageous configuration, it is proposed that the sorted succession of measurement datasets is sorted according to elevation angle. By way of example, the measurement datasets can be sorted according to ascending or descending elevation angle.

According to another advantageous configuration, it is proposed that the sorted succession of measurement datasets is sorted according to timestamp. By way of example, the measurement datasets can be sorted according to ascending or descending timestamp or according to ascending or descending time series.

According to another advantageous configuration, it is proposed that the measurement datasets are filtered according to the position of the GNSS receiver. In other words, this can also be described by stating that the measurement datasets are evaluated based on specific GNSS receiver positions or areas around specific GNSS receiver positions. Alternatively or additionally, there can be provision for the measurement datasets to be filtered according to azimuth angle.

A variant embodiment of step b) that is illustrative in this regard can be described as follows: the measurement datasets are first filtered according to the position of the GNSS receiver (for example by applying a quantization of one meter). For each GNSS receiver position, the measurement datasets are filtered according to azimuth angle. To simplify matters, this can be accomplished by quantizing the measurement datasets according to azimuth and elevation angle (for example with an angular degree). The quantization can entail the measurement datasets with identical or very similar azimuth and elevation angles being statistically combined (for example averaging).

For each azimuth angle, the measurement datasets in this regard are now sorted according to elevation angle (beginning with high elevation angle). The data sorted according to elevation angle are searched for the elevation angle at which the following traits occur for the first time: check on the pseudorange and/or signal strength for significant change in the event of decreasing elevation angle and/or whether the PR error exceeds a sensitivity limit (i.e. the state concerning whether a PR error can be measured changes from negative to positive). Measurement data that have had a positive check are “marked” accordingly. They are used as a hypothesis for there being a building edge at a point along the path, or the connecting line (cf. above explanation regarding borderline case consideration), between GNSS receiver and GNSS satellite. This is also referred to as an “edge hypothesis” here. The described search of the data sorted according to elevation angle can then be carried out, or repeated, for all other azimuth angles.

In this regard, to also render the pseudorange and signal powers of different GNSS satellites comparable if need be, it is moreover possible to calibrate the applicable offsets beforehand under LOS conditions. Alternatively, the offsets can also be calculated from the known satellite orbits and known transmission powers of the individual GNSS satellites. In this example, the sensitivity limit describes a threshold value (e.g. the standard deviation of the noise of the PR measurement) above which a PR error can be considered to be measurable.

An illustrative variant embodiment of step b) that is an alternative to this illustrative variant embodiment and that can also be described as evaluation on the basis of varying GNSS satellite position can be described as follows: the measurement datasets are first filtered according to the position of the reception antenna, or of the GNSS receiver (for example by applying a quantization of one meter). The measurement data are then sorted per GNSS satellite as a time series, or according to timestamp. In this regard, the pseudorange and/or signal strength in the time series is/are checked for significant change/sudden changes and/or whether the PR error exceeds or does not reach the sensitivity limit (i.e. the state concerning whether a PR error can be measured changes from negative to positive or vice versa). Measurement data that have had a positive check, e.g. because they have a significant change in the time series, are “marked” accordingly. They are used as a hypothesis for there being a building edge at a point along the path, or the connecting line (cf. above explanation regarding borderline case consideration), between GNSS receiver and GNSS satellite.

According to another advantageous configuration, it is proposed that the measurement datasets are filtered according to the position of the GNSS satellite. In other words, this can also be described by stating that the measurement datasets are evaluated based on specific GNSS satellite positions or areas around specific GNSS satellite positions.

A variant embodiment of step b) that is illustrative in this regard and that can also be described as evaluation on the basis of varying GNSS receiver position can be described as follows: the measurement datasets are filtered according to the position of the GNSS satellite (for example by using quantized ephemeris data). Measurement datasets for adjacent positions of the GNSS receiver, or of the reception antenna, are then compared. In this regard, the pseudorange and/or signal strength is/are checked for significant change/sudden changes and/or whether the ascertained PR error does not reach or exceeds the sensitivity limit (i.e. the state concerning whether a PR error can be measured changes from negative to positive or vice versa). Measurement data for adjacent positions of the GNSS receiver, or of the reception antenna, that exhibit a significant change are “marked” accordingly. They are used as a hypothesis for there being a building edge at a point along the path, or the connecting line (cf. above explanation regarding borderline case consideration), between reception antenna and GNSS satellite.

According to another advantageous configuration, it is proposed that at least the following intermediate steps are carried out in step c):
i) selecting at least two of the measurement datasets that meet a second selection criterion from the measurement datasets selected in step b), wherein the second selection criterion is characteristic of the presence of the same object boundary (in particular the same object edge) along the propagation paths of the at least two GNSS signals,
ii) forming a plane in which at least sections of the propagation paths of the at least two GNSS signals run.

The second selection criterion can in particular be characteristic of the presence of the same object boundary (in particular the same object edge) along the connecting lines between satellite and receiver position for at least two measurement datasets “marked” in b). In this regard, intermediate step ii) can entail the plane being formed from the connecting lines selected in intermediate step i). The plane can in particular also be understood to mean that it forms a so-called hypothesis area, for which it is assumed that a building edge runs within this plane/area.

Following on from the illustrative variant embodiments of step b) that are described above, an illustrative variant embodiment of step c) can be described as follows: the elevation and azimuth angles of the marked measured values (hypothesis for building edge along connecting line between satellite and reception antenna) are now processed further and can subsequently be referred to as hypothesis vectors. A hypothesis vector in this scenario generally forms a straight line between the GNSS receiver position and the GNSS satellite whose measurement data have been marked from the receiver position currently under consideration. Two hypothesis vectors that are adjacent in the azimuth direction are connected to form area elements (as a result of which the latter span the plane) if the following traits (1) and (2) (which are an example of the second selection criterion) exist: (1) The marked measured values corresponding to the hypothesis vectors originate from measurements that are adjacent in the azimuth direction (i.e. if there is, for example between the two azimuth angles of the two hypothesis vectors under consideration, an azimuth angle for which, although measurement data are available, no marking was performed for them, then the two hypothesis vectors under consideration are not connected to form an area element). (2) The two hypothesis vectors in question have an elevation angle difference<Eₜₕᵣ (with for example Eₜₕᵣ=5°). This is intended to ensure that buildings are able to be separated more easily upward of certain height or position differences.

According to another advantageous configuration, it is proposed that at least two mutually different, nonparallel planes are formed, running in each of which there are at least sections of the propagation paths of at least two GNSS signals whose measurement datasets each meet the second selection criterion, and wherein an at least partial profile of the object boundary is ascertained from the line of intersection for the at least two planes. In this regard, the two planes are in particular those spanned from each of the azimuth and elevation angles of two measurement datasets that meet the first and second selection criteria.

Following on from the illustrative variant embodiments of steps b) and c) that are described above, an illustrative variant embodiment in this regard can be described as follows: the area elements of two adjacent hypothesis vectors can subsequently be referred to as hypothesis areas, for which it is assumed that there is a building edge running within this area. An edge hypothesis is formed from the line of intersection for at least two intersecting hypothesis areas. The edge hypothesis represents the assumed profile of a building edge. The formation of area hypotheses is repeated for different reception antenna positions, or GNSS receiver positions. This takes place for example until the measurement data for a defined region (for example for a road) have been examined. The different hypothesis areas for the examined measurement data are processed further. The hypothesis areas of different positions are examined for lines of intersection. Lines of intersection are interpreted as building edges. They therefore represent the position and height of the building facade.

The lines of intersection can further be filtered, for example by applying partial linear regression. The steps described can be repeated so often until the entire spatial region to be examined has been processed.

According to another advantageous configuration, it is proposed that a distance between the object and the GNSS receiver is ascertained. This concerns in particular the horizontal distance between the object and the GNSS receiver. In this regard, the distance can be calculated for example according to the formula X=ε/(2 cos (θ)). Here, X describes the horizontal distance, ε describes the pseudorange error and 0 describes the elevation angle.

According to another aspect, a computer program for carrying out a method that is described here is also proposed. In other words, this concerns in particular a computer program (product), comprising instructions that, when the program is executed by a computer, cause said computer to perform a method that is described here. According to another aspect, a machine-readable storage medium on which the computer program is stored is also proposed. The machine-readable storage medium is normally a computer-readable data medium.

There is additionally intended to be a description here of a position sensor designed to carry out a method that is described here. By way of example, the storage medium described above can be part of the position sensor or may be connected thereto. The position sensor is preferably arranged in or on a (motor) vehicle or intended and designed for installation in or on such a vehicle. The position sensor is preferably a GNSS sensor. The position sensor is moreover preferably intended and designed for autonomous operation of the vehicle. Moreover, the position sensor can be a combined motion and position sensor. Such a sensor is particularly advantageous for autonomous vehicles. By way of example, the position sensor, or a computing unit (processor) of the position sensor, can access the computer program described here in order to perform a method that is described here.

The details, features and advantageous configurations discussed in regard to the method can accordingly also arise for the position sensor, the computer program and/or the storage medium presented here, and vice versa. In this respect, reference is made to the entire content of the embodiments there for the purpose of characterizing the features in more detail.

The solution presented here and the technical environment for said solution are explained more thoroughly below with reference to the figures. It should be pointed out that the invention is not intended to be restricted by the exemplary embodiments shown. In particular, unless explicitly shown otherwise, it is also possible to extract partial aspects of the substantive matter explained in the figures and to combine said partial aspects with other parts and/or insights from other figures and/or the present description. In the figures:

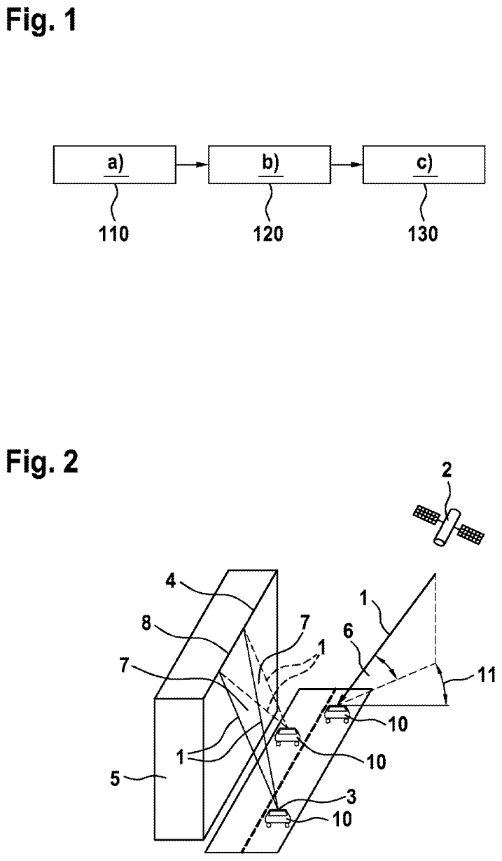

FIG. 1: schematically shows a flowchart for the described method,

FIG. 2: schematically shows vehicles in which a method that is described here is used, in urban surroundings, and

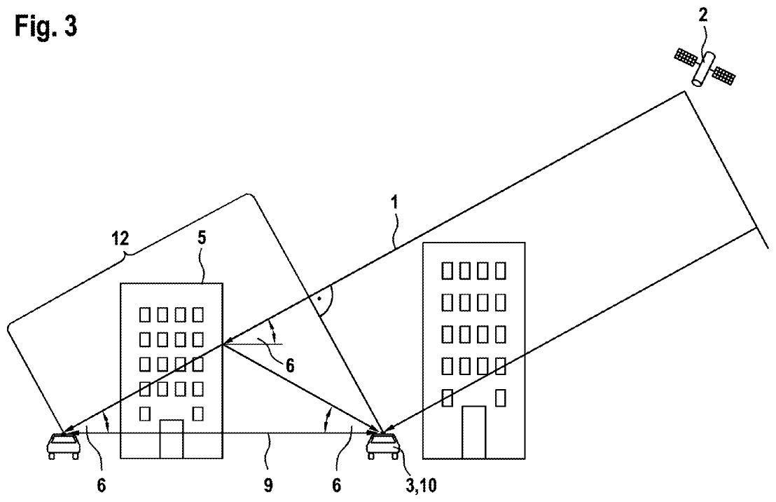

FIG. 3: schematically shows a representative graphical illustration of the occurrence of a pseudorange error.

FIG. 1 schematically shows a flowchart for the described method. The method is used to generate a three-dimensional environment model using GNSS measurements. The order of steps a), b) and c) that is depicted by the blocks 110, 120 and 130 is merely illustrative and can arise as such for a normal operating cycle, for example.

In block 110, step a) involves receiving a multiplicity of measurement datasets that each describe a propagation path 1 (not depicted here, cf. FIG. 2) of a GNSS signal between a GNSS satellite 2 and a GNSS receiver 3. In block 120, step b) involves selecting single instances of the measurement datasets that meet a first selection criterion from the multiplicity of measurement datasets, wherein the first selection criterion is characteristic of the presence of an object boundary 4 along the propagation path 1 of the GNSS signal. In block 130, step c) involves registering an object boundary 4 of an object 5 in the environment of at least one GNSS receiver 3 by using the selected measurement datasets.

FIG. 2 schematically shows vehicles 10 in which a method that is described here is used, in urban surroundings.

The measurement datasets that are recorded, and subsequently received by a central data processing device, for example, each comprise: the actual position of the reception antenna, or of the GNSS receiver 3, which can be ascertained for example by means of an on-vehicle environment sensor system (not depicted here) using the position of the respective vehicle 10; the satellite position of the GNSS satellite 2; the measured pseudorange (cf. FIG. 3); and the measured signal strength of the GNSS signal. By way of illustration, the measurement datasets here are first collected over a relatively long period, e.g. 10 days, and using crowdsourcing (i.e. the measurements of different measurement instances are collated). Three vehicles 10 are shown by way of illustration here as an example of different measurement instances for crowdsourcing.

By way of illustration, the first selection criterion here is that the measurement dataset to be selected within a sorted succession of measurement datasets is the first or last measurement dataset for which disturbed signal propagation can be determined. The sorted succession of measurement datasets is sorted according to elevation angle 6 by way of illustration here. Alternatively, however, it is also conceivable for the sorted succession of measurement datasets to be sorted according to timestamp. Furthermore, the measurement datasets are filtered according to the position of the GNSS receiver 3 by way of illustration here. Alternatively, however, it is also conceivable for the measurement datasets to be filtered according to the position of the GNSS satellite 2.

The variant embodiment of step b) that is implemented by way of illustration here can be described as follows: the measurement datasets are first filtered according to the position of the GNSS receiver 3 (for example by applying a quantization of one meter). For each GNSS receiver position, the measurement datasets are filtered according to azimuth angle 11. To simplify matters, this can be accomplished by quantizing the measurement datasets according to azimuth angle 11 and elevation angle 6 (for example with an angular degree). The quantization can entail the measurement datasets with identical or very similar azimuth angle 11 and elevation angle 6 being statistically combined (for example averaging).

For each azimuth angle 11, the measurement datasets in this regard are now sorted according to elevation angle 6 (beginning with high elevation angle 6). The data sorted according to elevation angle 6 are searched for the elevation angle 6 at which the following traits occur for the first time: check on the pseudorange and/or signal strength for significant change in the event of decreasing elevation angle and/or whether the PR error exceeds a sensitivity limit (i.e. the state concerning whether a PR error can be measured changes from negative to positive). The “pseudorange” in this scenario describes the total length, ascertained on the basis of propagation delay measurement, of the propagation path 1 (if applicable reflected at least once) from satellite 2 to receiver 3.

Measurement data that have had a positive check are “marked” accordingly. They are used as a hypothesis for there being a building edge 4 at a point along the path 1 (the connecting line) between reception antenna, or GNSS receiver 3, and GNSS satellite 2. This is also referred to as an “edge hypothesis” here. The described search of the data sorted according to elevation angle 6 can then be carried out, or repeated, for all other azimuth angles 11.

In this regard, to also render the pseudorange and signal powers of different GNSS satellites 2 comparable if need be, it is moreover possible to calibrate the applicable offsets beforehand under LOS conditions. Alternatively, the offsets can also be calculated from the known satellite orbits and known transmission powers of the individual GNSS satellites 2. In this example, the sensitivity limit describes a threshold value (e.g. the standard deviation of the noise of the PR measurement) above which a PR error 12 (cf. FIG. 3) can be considered to be measurable.

Moreover, FIG. 2 is used to illustrate that at least the following intermediate steps can be carried out in step c):
i) selecting at least two of the measurement datasets that meet a second selection criterion from the measurement datasets selected in step b), wherein the second selection criterion is characteristic of the presence of the same object boundary 4 along the propagation paths 1 of the at least two GNSS signals,
ii) forming a plane 7 in which at least sections of the propagation paths 1 of the at least two GNSS signals run.

Following on from the illustrative variant embodiment of step b) that is described above, the variant embodiment of step c) that is implemented by way of illustration here can be described as follows: the elevation angle 6 and the azimuth angle 11 of the marked measured values (hypothesis for building edge 4) are now processed further and can subsequently be referred to as hypothesis vectors 1. A hypothesis vector 1 in this scenario generally forms a straight line between the GNSS receiver position 3 and the GNSS satellite 2 whose measurement data have been marked from the receiver position currently under consideration. Two hypothesis vectors 1 that are adjacent in the azimuth direction 11 are connected to form area elements 7 (as a result of which the latter span the plane 7) if the following traits (1) and (2) exist: (1) The marked measured values corresponding to the hypothesis vectors 1 originate from measurements that are adjacent in the azimuth direction 11 (i.e. if there is, for example between the two azimuth angles 11 of the two hypothesis vectors 1 under consideration, an azimuth angle 11 for which, although measurement data are available, no marking was performed for them, then the two hypothesis vectors 1 under consideration are not connected to form an area element 7). (2) The two hypothesis vectors 1 in question have an elevation angle difference<Eₜₕᵣ (with for example Eₜₕᵣ=) 5°. This is intended to ensure that buildings 5 are able to be separated more easily upward of certain height or position differences.

Moreover, FIG. 2 illustrates that at least two mutually different, nonparallel planes 7 are formed, running in each of which there are at least sections of the propagation paths 1 of at least two GNSS signals whose measurement datasets each meet the second selection criterion, and wherein an at least partial profile of the object boundary 4 is ascertained from the line of intersection 8 for the at least two planes 7.

Following on from the illustrative variant embodiments of steps b) and c) that are described above, the variant embodiment in this regard that is implemented by way of illustration here can be described as follows: the connected area elements of two adjacent hypothesis vectors 1 can subsequently be referred to as hypothesis areas 7. The search for edge hypotheses is repeated for different reception antenna positions, or GNSS receiver positions. This takes place for example until the measurement data for a defined region (for example for a road) have been examined. The different hypothesis areas 7 for the examined measurement data are processed further. The hypothesis areas 7 of different positions 3 are examined for lines of intersection 8. Lines of intersection 8 are interpreted as building edges 4. They therefore represent the position and height of the building facade.

FIG. 3 schematically shows a representative graphical illustration of the occurrence of a pseudorange error 12. FIG. 3 is also used to illustrate that a distance 9 between the object 5 and the GNSS receiver 3 can be ascertained.

In this regard, the collected measurement data can be used for example to obtain statements relating to the distance 9 of a building wall from the reception antenna, or the GNSS receiver 3. As FIG. 3 illustrates, the PR error 12 (symbol: ε) is obtained on the basis of the distance 9 (symbol: X) (collinear with respect to the normal vector of the reflecting area) between reception antenna and reflecting wall to produce ε=2*X*cos (θ), or X=ε/(2 cos (θ)). θ is the elevation angle here.

The distance 9 collected from the PR error 12 can be used to adapt the position of the generated building wall (e.g. by shifting). This can optionally take place in a post-processing (that is to say after steps a) to c)). Alternatively, the distance between receiver position and reflecting object can also be taken into consideration during calculation of the building walls already (that is to say during steps a) to c)).

1. A method for generating a three-dimensional environment model using GNSS measurements, the method comprising:
a) receiving a plurality of measurement datasets that each describe a respective propagation path of a respective GNSS signal between a respective GNSS satellite and a respective GNSS receiver;
b) selecting measurement datasets from the plurality measurement datasets that meet a first selection criterion, the first selection criterion being characteristic of a presence of an object boundary along the respective propagation path of the respective GNSS signal; and
c) registering an object boundary of an object in an environment of a first GNSS receiver using the selected measurement datasets.

2. The method as claimed in claim 1, wherein the first selection criterion is that the each of the selected measurement datasets within a sorted succession of measurement datasets from the plurality of measurement datasets is one of a first measurement dataset and a last measurement dataset for which disturbed signal propagation is determined.

3. The method as claimed in claim 2, wherein the sorted succession of measurement datasets is sorted according to respective elevation angles.

4. The method as claimed in claim 2, wherein the sorted succession of measurement datasets is sorted according to respective timestamps.

5. The method as claimed in claim 1, wherein the plurality of measurement datasets are filtered according to a respective position of the respective GNSS receiver.

6. The method as claimed in claim 1, wherein the plurality of measurement datasets are filtered according to a respective position of the respective GNSS satellite.

7. The method as claimed in claim 1, further comprising, after the c) registering:
i) selecting at least two measurement datasets from the selected measurement datasets in step b) that meet a second selection criterion, the second selection criterion being characteristic of a presence of a same object boundary along the respective propagation paths of the at least two respective GNSS signals; and
ii) forming a plane in which at least sections of the respective propagation paths of the at least two respective GNSS signals of the selected at least two measurement datasets run.

8. The method as claimed in claim 7 further comprising:
forming at least two planes, which are mutually different and nonparallel, each having running therein at least sections of the respective propagation paths of at least two respective GNSS signals of at least two measurement datasets that each meet the second selection criterion; and
ascertaining an at least partial profile of the object boundary of the object from a line of intersection for the at least two planes.

9. The method as claimed in claim 1 further comprising:
ascertaining a distance between the object and the first GNSS receiver.

10. The method according to claim 1, wherein the method is carried out by executing a computer program.

11. A non-transitory machine-readable storage medium that stores a computer program for generating a three-dimensional environment model using GNSS measurements, the computer program being configured to, when executed:
a) receiving a plurality of measurement datasets that each describe a respective propagation path of a respective GNSS signal between a respective GNSS satellite and a respective GNSS receiver;
b) selecting measurement datasets from the plurality measurement datasets that meet a first selection criterion, the first selection criterion being characteristic of a presence of an object boundary along the respective propagation path of the respective GNSS signal; and
c) registering an object boundary of an object in an environment of a first GNSS receiver using the selected measurement datasets.
